(19) United States
(12) Patent Application Publication
(10) Pub. No.: US 2019/0165353 A1
(43) Pub. Date: May 30, 2019

(54) ELECTRODE ASSEMBLY, BATTERY AND PACKAGING METHOD OF SEPARATOR OF ELECTRODE ASSEMBLY

(71) Applicant: Ningde Amperex Technology Limited, Ningde (CN)

(72) Inventors: Junhui Hou, Ningde (CN); Weimin Jiao, Ningde (CN); Houlei Cui, Ningde (CN); Zhiwen Xiao, Ningde (CN); Lijian Zhou, Ningde (CN)

(21) Appl. No.: 16/203,651

(22) Filed: Nov. 29, 2018

(30) Foreign Application Priority Data
Nov. 30, 2017 (CN) 201711237384.9

(51) Int. Cl. H01M 2/26; H01M 2/16; H01M 2/14; H01M 10/04

(52) U.S. Cl. CPC H01M 2/263; H01M 10/0431; H01M 2/145; H01M 2/1673

(57) ABSTRACT

The present application provides an electrode assembly comprising a body and a separator extension formed by a separator extending from the body, wherein the separator extension includes a first extension and a second extension, the second extension including a first stack portion and a second stack portion, the second stack portion being folded over onto the first stack portion. The present application further provides a battery and a packaging method of separator of the electrode assembly. The purpose of the present application is to provide an electrode assembly, a battery and a packaging method of electrode assembly separator, which can solve the problem of separator shrinkage during the falling process.

### CROSS-REFERENCE TO RELATED APPLICATIONS

The present application claims priority to Chinese Patent Application No. 201711237384.9, filed on Nov. 30, 2017, the content of which is incorporated herein by reference in its entirety.

### FIELD OF THE INVENTION

The present application relates to the field of battery, in particular, to an electrode assembly, a battery and a packaging method of electrode assembly separator.

### BACKGROUND OF THE INVENTION

In the battery structure, a separator is arranged between a positive electrode plate and a negative electrode plate, a width of the separator is slightly larger than that of the positive and negative electrode plates, and forming an extension of the separator beyond the positive and negative electrode plates. In the drop test, there is a problem that the extension shrinks into a gap between the positive and negative electrode plates, and hence the positive and negative electrode plates are contacted together to cause a short circuit between the positive and negative electrodes.

### SUMMARY OF THE INVENTION

For the problems in the related art, the purpose of the present application is to provide an electrode assembly, a battery and a packaging method of electrode assembly separator, which can solve the problem of separator shrinkage during the falling process.

According to embodiments of the present application, an electrode assembly is provided comprising a body and a separator extension formed by a separator extending from the body, wherein the separator extension includes a first extension and a second extension, the second extension including a first stack portion and a second stack portion, the second stack portion being folded over onto the first stack portion.

According to embodiments of the present application, in a thickness direction of the body, a height of the second extension is less than or equal to a thickness of the body.

According to embodiments of the present application, the body has a first surface and a second surface in a thickness direction, and the second extension is in a same plane as the first surface of the body.

According to embodiments of the present application, the second stack portion is fixed on the first stack portion.

According to embodiments of the present application, the electrode assembly further includes a fixing member that passes through the first stack portion and the second stack portion.

According to embodiments of the present application, the fixing member is a glue column.

According to embodiments of the present application, the adjacent second extensions are bonded together.

According to embodiments of the present application, a battery is further provided comprising a packaging shell and an electrode assembly, wherein the electrode assembly is located within the packaging shell and the electrode assembly is the electrode assembly as described in any of the above embodiments.

According to embodiments of the present application, a packaging method of a separator of an electrode assembly is further provided comprising steps of stacking extensions of the separator exposed from a body, and folding the extensions of the separator with an angle of 180 degrees.

According to embodiments of the present application, the body has a first surface and a second surface that are opposed to each other in a thickness direction, wherein the packaging method further comprises: stacking the extensions to a plane in which the first surface is located; and folding the extensions to a region between the first surface and the second surface.

According to embodiments of the present application, it further comprising: before folding the extensions, fixing the extensions; or after folding the extensions, fixing the extensions and the stack portions.

The beneficial technical effects of the present application are as follows:

In the present application, the second stack portion in the second extension of the separator extension is folded and flipped onto the first stack portion such that the separators in the separator extension are mutually restricted. Therefore, it is possible to prevent the separator from shrinking into the gap between the positive and negative electrode plates, to avoid the short circuit of the positive and negative electrodes caused by the shrinkage of the separator, and to improve the drop performance of the battery. At the same time, since the extension of the separator is folded, the problem that the volume of the electrode assembly inside the battery is increased due to the extension of the separator is avoided, thereby ensuring that the battery has a high energy density.

### BRIEF DESCRIPTION OF THE DRAWINGS

FIG. 1 is a schematic cross-sectional view of a winding structure of an electrode assembly according to an embodiment.

FIG. 2 is a side view of a separator of the electrode assembly after folding according to an embodiment.

FIG. 2A is a side view of the separator of the electrode assembly after folding according to another embodiment.

FIG. 3 is a schematic view of the integration of the separator of electrode assembly according to an embodiment.

FIG. 4 is a schematic view of the separator of electrode assembly after folding according to still another embodiment.

FIG. 5 is a schematic flow chart of a packaging method of the separator of the electrode assembly according to an embodiment.

### DETAILED DESCRIPTION OF THE PREFERRED EMBODIMENTS

The embodiments of the present application will be described in detail in connection with the attached drawings. The description of the present application in accordance to drawings is intended to be illustrative, and not restrictive. The various embodiments may be combined with one another to form other embodiments not shown in the following description. In addition, the various orientation terms used in the following description are also merely illustrative and are not intended to limit the present application.

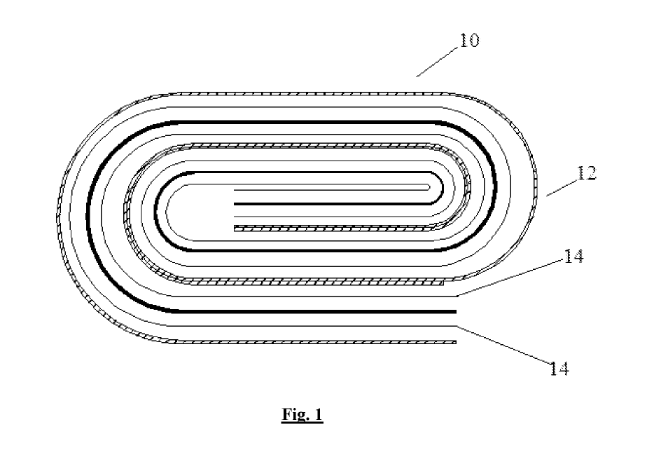

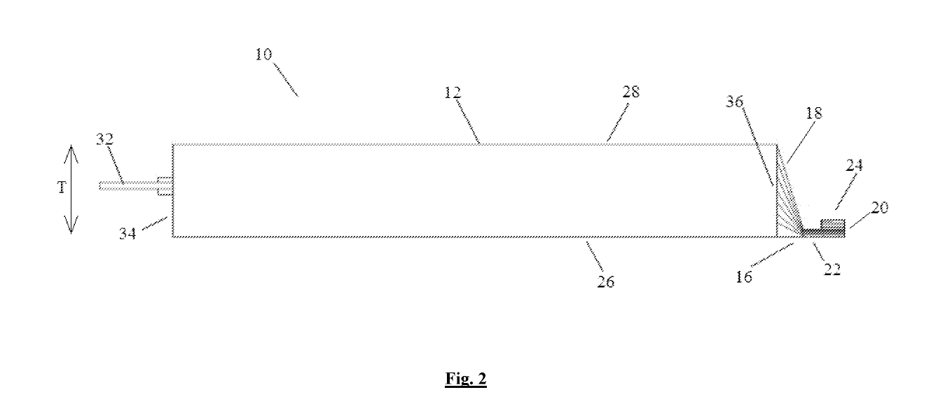

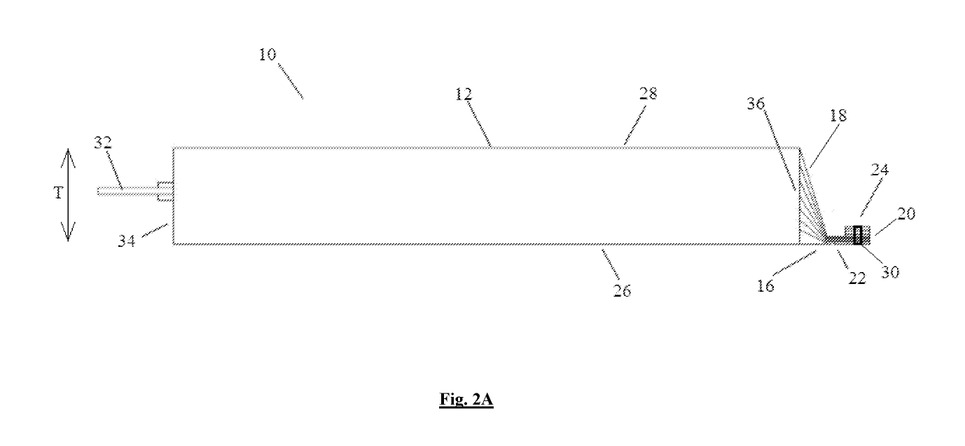

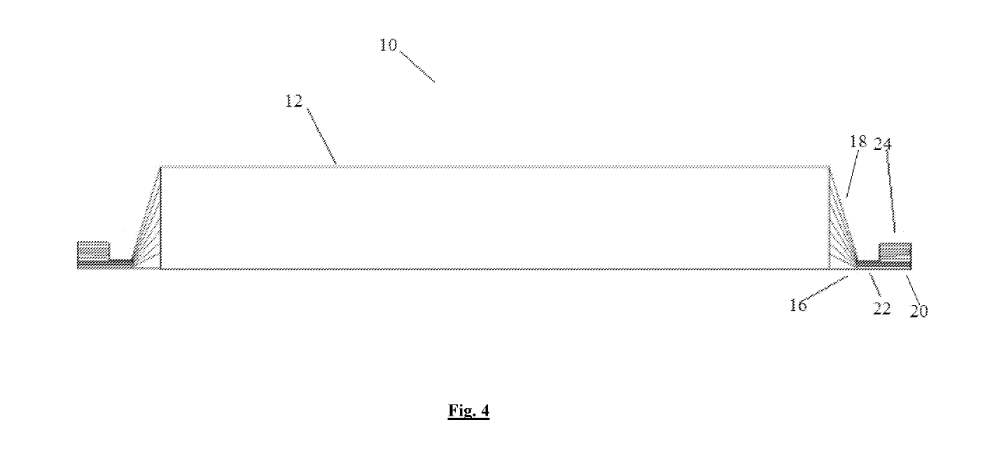

With reference to FIGS. 1 to 5, in various embodiments of the present application, an electrode assembly 10, a battery having the electrode assembly 10 and a packaging method of separator of electrode assembly are provided. The present application will be described below in conjunction with the embodiments shown in the various figures. It should be noted herein that the embodiments of the present application are applicable to any types of electrode assembly, such as a wound electrode assembly as shown in FIG. 2, a laminated electrode assembly shown in FIG. 4, and the like. In other words, embodiments of the present application are not limited to any one of the electrode assembly structures. For different types of electrode assemblies, the electrode tab 32 extends from respective appropriate locations of the body 12, such as from the top of the body 12 (e.g., the embodiment shown in FIG. 2) or any one or more sides (e.g., embodiment shown in FIG. 4). That is, the following embodiments of the present application are merely exemplary and are not intended to limit the present application.

Further as shown, the electrode assembly 10 includes a body 12 and a separator extension 16. The separator extension 16 is a portion of a separator 14 that extends from the body 12. Specifically, as shown in FIG. 2, the separator extension 16 includes a first extension 18 and a second extension 20. The second extension 20 includes a first stack portion 22 and a second stack portion 24, and the second stack portion 24 is folded over onto the first stack portion 22, thereby forming a U-shaped structure as shown.

In the exemplary embodiment shown in FIGS. 1 to 2A, taking a wound battery as an example, for example, the electrode assembly 10 further comprises an electrode tab 32, and the body 12 includes a top 34 and a bottom 36 opposite to the top 34. The electrode tab 32 is mounted on the top 34 of the body 12, and the separator extension 16 is located at the bottom 36 of the body 12. It should be understood that the above description is merely an illustrative embodiment of the present application and does not constitute any limitation to the present application.

It should be understood that for the electrode assembly 10 described above, it includes the positive and negative electrode plates and the separator 14. The positive and negative electrode plates are separated by the separator 14, the width of the separator 14 should be greater than the width of the positive and negative electrode plates, and the portion of the separator 14 that exceeds the width of the positive and negative electrode plates is referred to as an extension of the separator 14 (i.e., the separator extension 16). According to embodiments provided by the present application, the second stack portion 24 in the second extension 20 of the separator extension 16 is folded over onto the first stack portion 22 such that the separators 14 in the separator extension 16 are mutually restricted. Therefore, it is possible to prevent the separator 14 from shrinking into the gap between the positive and negative electrode plates, to avoid the short circuit of the positive and negative electrodes caused by the shrinkage of the separator 14, and to improve the drop performance of the battery. At the same time, since the separator extension 16 is folded, the problem that the volume of the electrode assembly inside the battery is increased due to the separator extension 16 is avoided, thereby ensuring that the battery has a high energy density. And on the other hand, the structure provided by the present application does not introduce a chemical substance, thereby eliminating the winding process and improving the electrode assembly drop performance.

Specifically, according to above-described embodiments, folding the second stack portion 24 of the second extension 20 onto the first stack portion 22 to form the U-shaped structure means that, for example, both the first stack portion 22 and the second stack portion 24 after folding are arranged to be perpendicular to the bottom 36 of the body 12. In other words, the first stack portion 22 and the second stack portion 24 formed after folding are substantially parallel to the two opposing side walls or opposing surfaces of the body 12 (e.g., surfaces 26, 28 as shown in FIG. 2, described below). It is apparent that this structure in which the extension of the separator 14 is folded into a U shape may better prevent the shrinkage of the separator 14.

It should be understood here that the folding of the second stack portion 24 by 180 degrees as described above does not limit the direction in which it is folded. For example, in the embodiment as shown, the second stack portion 24 is folded toward the plane in which the second surface 28 is located (in other words, it is folded upward/counterclockwise in the embodiment as shown); in other embodiments, the second stack portion 24 may also be folded downward/clockwise. Therefore, the direction of folding does not limit the present application.

With continuous reference to the embodiment as shown, in a thickness direction T of the body 12, a height of the second extension 20 is less than or equal to a thickness of the body 12. That is, the first and second stack portions 22, 24 of the second extension portion 20 are each located in a region between the two surfaces (e.g., surfaces 26, 28) of the body 12 in the thickness direction. In this way, the extension of the separator 14 is made to be defined in the region between the two surfaces after folding, so that the thickness of the entire electrode assembly 10 is less affected.

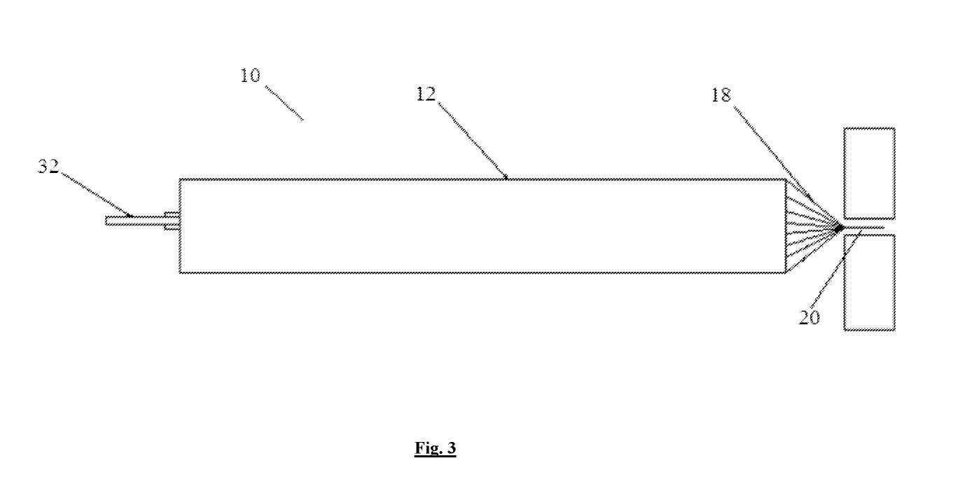

Specifically, in an embodiment, the body 12 has a first surface 26 and a second surface 28 as described above in the thickness direction T, and the second extension 20 is in the same plane as the first surface 26 of the body 12. That is, as shown in FIGS. 2, 2A and 4, when the integration of the separator extension 16 is performed, it is integrated toward, for example, the plane in which the first surface 26 is located, thereby forming a structure as shown. Of course, it will be understood that in other alternative embodiments, such as shown in FIG. 3, the separator extension 16 may also be formed at any location in the region between the first surface 26 and the second surface 28.

According to the above description, as shown in FIG. 3, when the second extension 20 is located at a position in the region between the first surface 26 and the second surface 28, both sides of the separator 14 may be pressed in the integration process of the separator 14 to integrate the separator 14 together. And when the connection location is on the plane of one of the surfaces (for example, the first surface 26; for the second surface 28, similar to the structure of the first surface 26) (as shown in FIGS. 2, 2A, 4), it is only necessary to press one side during the integration process of the separator 14 to make the operation process simpler. Further, when the second extension 20 is integrated toward the plane in which one of the surfaces is located, the folding space at the time of subsequent folding of the extension may be made larger.

In addition, it should be pointed out here that when the second extension 20 is extended from a direction flush with one of the surfaces (e.g., the surface 26) and folded toward a region between the opposite surfaces 26, 28 of the body 12 in the thickness direction, the effect on the volumetric energy density of the electrode assembly 10 is smaller.

Further, as shown in FIG. 2A, in an alternative embodiment of the present application, the second stack portion 24 as described above is fixed to the first stack portion 22. Specifically, in an embodiment, the electrode assembly 10 further comprises a fixing member 30, the fixing member 30 passing through the first stack portion 22 and the second stack portion 24. Optionally, in an embodiment, the fixing member 30 is a glue column; in other embodiments any suitable fixing member may be employed. For the above structure, fixing the first stack portion 22 and the second stack portion 24 together prevents the separator 14 from shrinking into the gap between the positive and negative electrode plates, and since the extension of the separator 14 is folded to be U-shaped, the problem of an increase in the volume of the electrode assembly by the separator extension 16 may be effectively improved, and the extension of the separator 14 is more stable and less likely to shrink.

Of course, it should be understood that the above-described fixing manner is only an exemplary embodiment of the present application; in other optional embodiments, the first stack portion 22 and the second stack portion 24 may be fixed to each other by other means, and the present application is not limited thereto.

In an alternative embodiment, for example, adjacent second extensions 20 may also be bonded together by bonding to restrict the extensions of adjacent separators mutually, thereby achieving stability and difficulty to shrink.

In the particular application of the electrode assembly 10 provided herein, it may be placed in various types of batteries such that the battery accordingly has all of the advantages described above. For example, the present application provides a battery including a packaging shell, and an electrode assembly as described above accommodated in the packaging shell.

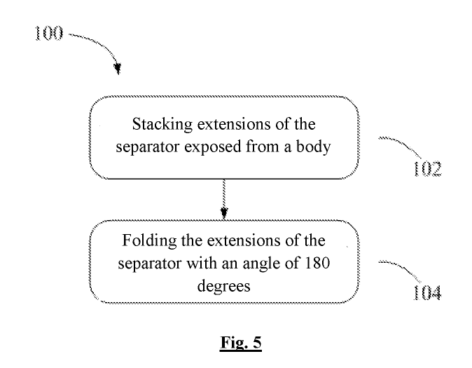

Referring again to FIGS. 1 to 4 and in conjunction with FIG. 5, a specific packaging method of the separator 14 of the electrode assembly 10 provided by the present application is described. It should be understood that the methods and steps described below are merely illustrative and are not intended to limit the present application. Occlusions, changes, replacement sequences, and the like may occur between the various steps, and such modifications are included in the scope of the present application.

For example, as shown in FIG. 5, for the packaging method 100 of the electrode assembly separator provided by the present application, the method 100 generally includes steps of: in step 102, stacking the extension of the separator 14 exposed from the body 12; and in step 104, folding the extension of the separator 14 with an angle of 180 degrees.

Further, the packaging method further comprises steps of: stacking the extension to a plane in which the first surface 26 is located; and folding the extension to a region between the first surface 26 and the second surface 28.

In addition, according to alternative embodiments, the method further comprises steps of: before folding the extensions, fixing the extensions; or after folding the extension, fixing the extensions and the stack portions. For example, the separator may be thermally welded and fixed by, for example, hot pressing.

By the method described above, it is possible to prevent the separator 14 from shrinking into the gap between the positive and negative electrode plates, and since the extension is folded into a U shape, the problem resulted from the separator extension 16 that the volume of the electrode assembly is increased may be improved. Furthermore, it should be understood that connecting the extensions together before or after the folding step may make the extension of the folded separator 14 more stable and less prone to shrinkage. Of course, the extension of the separator 14 may be connected by means of hot pressing, adhesive, fixing of the fixing member through the separator, and the like. In other words, based on the packaging method provided by the present application, the electrode assembly structure provided by the present application as described above may be formed, such that the above-described packaging method may also achieve the beneficial effects of the electrode assembly structure.

The foregoing is merely illustrative of the preferred embodiments of the present application and is not intended to be limiting of the present application, and various changes and modifications may be made by those skilled in the art. Any modifications, equivalent substitutions, improvements, and the like within the spirit and principles of the application are intended to be included within the scope of the present application.

What is claimed is:

1. An electrode assembly, comprising:
a body; and
a separator extending from the body and comprising a separator extension beyond the body,
wherein the separator extension comprises a first extension and a second extension, the second extension comprises a first stack portion and a second stack portion, and the second stack portion is folded over onto the first stack portion.

2. The electrode assembly according to claim 1, wherein in a thickness direction of the body, a height of the second extension is less than or equal to a thickness of the body.

3. The electrode assembly according to claim 1, wherein the body has a first surface and a second surface in a thickness direction, and the second extension is in a same plane with the first surface of the body.

4. The electrode assembly according to claim 1, wherein the second stack portion is fixed on the first stack portion.

5. The electrode assembly according to claim 4, wherein the electrode assembly further comprises a fixing member that passes through the first stack portion and the second stack portion.

6. The electrode assembly according to claim 5, wherein the fixing member is a glue column.

7. The electrode assembly according to claim 1, wherein two adjacent second extensions are bonded together.

8. The electrode assembly according to claim 1, further comprising an electrode tab, wherein the body comprises a top and a bottom opposite to the top, the electrode tab is mounted on the top of the body, and the separator extension is located at the bottom of the body.

9. The electrode assembly according to claim 1, wherein the electrode assembly is a wound electrode assembly.

10. A battery, comprising a packaging shell and an electrode assembly located in the packaging shell,
wherein the electrode assembly comprises a body and a separator extending from the body and comprising a separator extension beyond the body,
wherein the separator extension comprises a first extension and a second extension, the second extension comprises a first stack portion and a second stack portion, and the second stack portion is folded over onto the first stack portion.

11. The battery according to claim 10, wherein in a thickness direction of the body, a height of the second extension is less than or equal to a thickness of the body.

12. The battery according to claim 10, wherein the body has a first surface and a second surface in a thickness direction, and the second extension is in a same plane with the first surface of the body.

13. The battery according to claim 10, wherein the second stack portion is fixed on the first stack portion.

14. The battery according to claim 13, wherein the electrode assembly further comprises a fixing member that passes through the first stack portion and the second stack portion.

15. The battery according to claim 14, wherein the fixing member is a glue column.

16. The battery according to claim 10, wherein the adjacent second extensions are bonded together.

17. The battery according to claim 10, further comprising an electrode tab, wherein the body comprises a top and a bottom that are opposed to each other, wherein the electrode tab is mounted on the top of the body and the separator extension is located at the bottom of the body.

18. A packaging method of a separator of an electrode assembly, comprising steps of:
stacking extensions of the separator exposed from a body; and
folding the extensions of the separator with an angle of 180 degrees.

19. The packaging method according to claim 18, wherein the body has a first surface and a second surface opposed to the first surface in a thickness direction, and the packaging method further comprises:
stacking the extensions to a plane in which the first surface is located; and
folding the extensions to a region between the first surface and the second surface.

20. The packaging method according to claim 18, further comprising:
before folding the extensions, fixing the extensions; or
after folding the extensions, fixing the extensions and the stack portions.
